(19) United States
(12) Patent Application Publication
(10) Pub. No.: US 2022/0365805 A1
(43) Pub. Date: Nov. 17, 2022

(54) DEVICE PASS-THROUGH METHOD FOR VIRTUAL MACHINE AND SERVER USING THE SAME

(71) Applicant: Acer Incorporated, New Taipei City (TW)

(72) Inventor: Kuan-Ju Chen, New Taipei City (TW)

(73) Assignee: Acer Incorporated, New Taipei City (TW)

(21) Appl. No.: 17/724,484

(22) Filed: Apr. 19, 2022

(30) Foreign Application Priority Data
May 14, 2021 (TW) 110117542

(51) Int. Cl. G06F 9/455; G06F 9/4401

(52) U.S. Cl. CPC G06F 9/45558; G06F 9/45545; G06F 9/4411; G06F 2009/45579

(57) ABSTRACT

A device pass-through method for a virtual machine (VM) and a server using the same method are provided. The method includes the following. A host operating system (OS) kernel including a device driver and a socket node corresponding to a hardware device and a VM including a guest OS and a guest kernel are established, and the guest OS includes an application and an analyzer. The guest kernel receives an I/O request command from the application and transmits an I/O request packet corresponding to the I/O request command to the analyzer. According to a virtual function (VF) name in the I/O request packet, the analyzer transmits an access packet corresponding to the I/O request command to the socket node corresponding to the VF name. The socket node accesses the device driver according to the access packet to drive the hardware device.

### CROSS-REFERENCE TO RELATED APPLICATION

This application claims the priority benefit of Taiwan application serial no. 110117542, filed on May 14, 2021. The entirety of the above-mentioned patent application is hereby incorporated by reference herein and made a part of this specification.

### BACKGROUND

### Technical Field

The disclosure relates to a device pass-through method for a virtual machine and a server using the same.

### Description of Related Art

A computing device simulates a computer system through virtual machine (VM) technology. A virtual machine may access a hardware device through device pass-through technology to control the hardware device through a host operating system (OS) kernel. Currently, a virtual machine can execute device pass-through through multiple methods. For example, a VirtIO device developed by an independent hardware vendor (IHV) may be installed in a guest kernel of a virtual machine. When a guest operating system of the virtual machine wants to transmit an access command to a host operating system, the guest operating system (guest OS) may transmit the access command through the VirtIO device to the host operating system to access the hardware device through the host operating system. In addition, the virtual machine may use single root I/O virtualization (SR-IOV) technology to access the hardware device through a virtual function (VF). Furthermore, the virtual machine may use veth technology to establish a channel between the virtual machine and the host operating system, and transmit the access command through the channel to the host operating system. However, users who use the above methods need to entrust an independent hardware vendor or an independent software vendor (ISV) with software development, which means that the users have to pay a fee.

On the other hand, the host operating system kernel may use a software (for example: QEMU or CrosVM) to generate a virtual device for the virtual machine to access. However, the above method significantly reduces the performance of the computing device.

### SUMMARY

The disclosure provides a device pass-through method for a virtual machine and a server using the same to optimize the performance of a virtual machine.

In the disclosure, a server of a virtual machine includes a processor, a storage medium, and a transceiver. The storage medium stores multiple modules. The processor is coupled to the storage medium and the transceiver, and accesses and executes the modules. The modules include a host operating system kernel and a virtual machine. The host operating system kernel is communicatively connected to a hardware device through the transceiver and includes a device driver and a socket node corresponding to the hardware device. The virtual machine includes a guest operating system and a guest kernel. The guest operating system includes an application and an analyzer. The guest kernel receives an I/O request command from the application and transmits an I/O request packet corresponding to the I/O request command to the analyzer. According to a virtual function name in the I/O request packet, the analyzer transmits an access packet corresponding to the I/O request command to the socket node corresponding to the virtual function name. The socket node accesses the device driver according to the access packet to drive the hardware device.

In an embodiment of the disclosure, the guest kernel includes a VirtIO device. The I/O request packet includes one of the virtual function name and a hardware ID. In response to the I/O request packet comprising the hardware ID, the analyzer transmits the access packet to the host operating system kernel through the VirtIO device corresponding to the hardware ID. The host operating system kernel accesses the device driver according to the access packet to drive the hardware device.

In an embodiment of the disclosure, in response to the socket node receiving the access packet, the host operating system kernel adds one to a count value corresponding to the socket node. The host operating system kernel outputs the count value through the transmitter.

In an embodiment of the disclosure, the analyzer generates the access packet according to the I/O request packet. The access packet includes an access command and a socket node name corresponding to the socket node.

In an embodiment of the disclosure, the access packet further includes a virtual machine address corresponding to the virtual machine. In response to driving the hardware device, the socket node transmits an output of the hardware device to the virtual machine according to the virtual machine address.

In an embodiment of the disclosure, the access packet includes a VirtIO device address corresponding to the VirtIO device. In response to driving the hardware device, the host operating system kernel transmits an output of the hardware device to the VirtIO device according to the VirtIO device address.

In an embodiment of the disclosure, the host operating system kernel detects the hardware device through the transceiver and establishes the device driver and the socket node in response to detecting the hardware device.

In an embodiment of the disclosure, in response to detecting the hardware device, the host operating system kernel transmits a configuration packet to the analyzer. The configuration packet includes a hardware ID corresponding to the hardware device, a socket node address corresponding to the socket node, and a socket node name corresponding to the socket node.

In an embodiment of the disclosure, the analyzer generates a mapping table of the virtual function name and the socket node name according to the configuration packet.

In an embodiment of the disclosure, the analyzer transmits the access packet to the socket node corresponding to the virtual function name according to the mapping table.

In an embodiment of the disclosure, the analyzer and the socket node communicate with each other through a vsock protocol.

In the disclosure, a device pass-through method for a virtual machine includes the following. A host operating system kernel and a virtual machine are established; the host operating system kernel includes a device driver and a socket node corresponding to a hardware device, the virtual machine includes a guest operating system and a guest kernel, and the guest operating system includes an application and an analyzer. The guest kernel receives an I/O request command from the application and transmits an I/O request packet corresponding to the I/O request command to the analyzer. According to a virtual function name in the I/O request packet, the analyzer transmits an access packet corresponding to the I/O request command to the socket node corresponding to the virtual function name. The socket node accesses the device driver according to the access packet to drive the hardware device.

Based on the above, the virtual machine of the disclosure communicates with the socket node dedicated to the hardware device to access the hardware device. Compared with accessing a hardware device through a virtual device by a conventional virtual machine, accessing the hardware device through the socket node avoids the occurrence of a binary translation process, thereby reducing the waste of computing resources.

### BRIEF DESCRIPTION OF THE DRAWINGS

FIG. 1 illustrates a schematic diagram of a server of a virtual machine according to an embodiment of the disclosure.

FIG. 2 illustrates a schematic diagram of a plurality of modules in a storage medium according to an embodiment of the disclosure.

FIG. 3 illustrates a flow chart of a device pass-through method for a virtual machine according to an embodiment of the disclosure.

FIG. 4 illustrates a flow chart of a method of a hardware device establishing a device pass-through channel according to an embodiment of the disclosure.

FIG. 5 illustrates a flow chart of a device pass-through method for another virtual machine according to an embodiment of the disclosure.

### DESCRIPTION OF THE EMBODIMENTS

To further describe the content of the disclosure, embodiments are described below as examples based on which the disclosure may be implemented. In addition, wherever possible, the elements/components/steps with denoted by the same reference numeral in the drawings and embodiments are represent the same or similar parts.

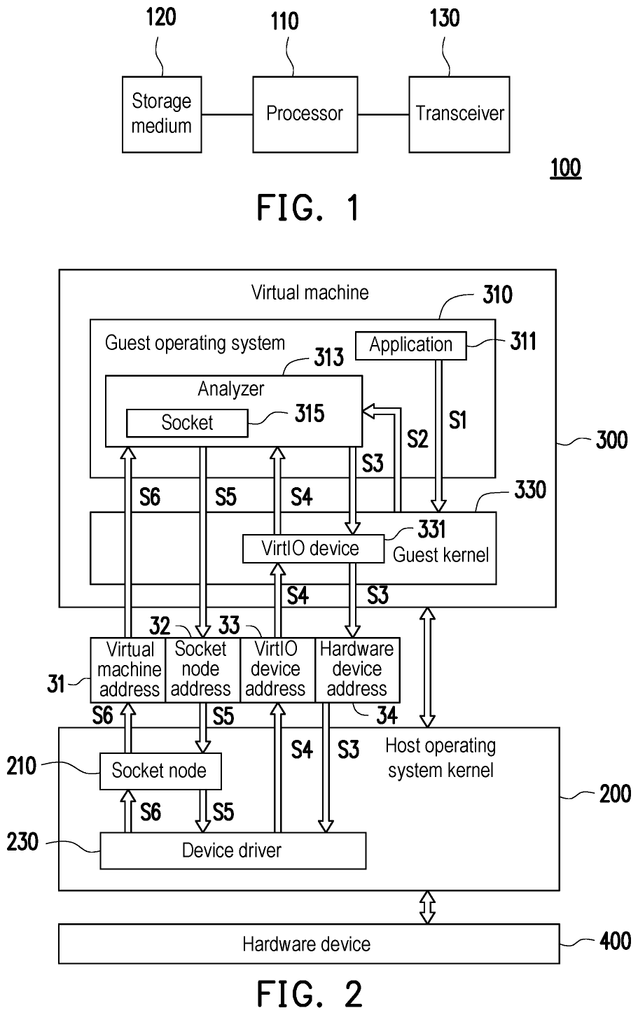

FIG. 1 illustrates a schematic diagram of a server 100 of a virtual machine according to an embodiment of the disclosure. The server 100 may include a processor 110, a storage medium 120, and a transceiver 130.

The processor 110 is, for example, a central processing unit (CPU), or other programmable general purpose or special purpose elements such as a micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar elements or a combination of the above elements. The processor 110 may be coupled to the storage medium 120 and the transceiver 130 and access and execute a plurality of modules and various applications stored in the storage medium 120.

The storage medium 120 is, for example, any type of fixed or removable element such as a random access memory (RAM), a read-only memory (ROM), a flash memory, a hard disk drive (HDD), a solid state drive (SSD), or a similar element or a combination of the above elements, and is adapted for storing a plurality of modules or various applications that may be executed by the processor 110.

The transceiver 130 transmits and receives signals in a wireless or wired manner. The transceiver 130 may further execute operations such as low noise amplification, impedance matching, frequency mixing, up or down frequency conversion, filtering, amplification and the like.

FIG. 2 illustrates a schematic diagram of a plurality of modules in the storage medium 120 according to an embodiment of the disclosure. The modules in the storage medium 120 may include a host operating system kernel 200 and a virtual machine 300. The host operating system kernel 200 may be communicatively connected to a hardware device 400 through the transceiver 130. The virtual machine 300 may access the hardware device 400 through the host operating system kernel 200. Although the embodiment of FIG. 2 implements the host operating system kernel 200 and the virtual machine 300 through a single device (that is, the server 100), the disclosure is not limited thereto. For example, the host operating system kernel 200 and the virtual machine 300 may be implemented by different computing devices that are communicatively connected to each other.

The host operating system kernel 200 may include a socket node 210 and a device driver 230 corresponding to the hardware device 400. The socket node 210 may access the hardware device 400 through the device driver 230. The virtual machine 300 is, for example, a kernel-based virtual machine (KVM). The virtual machine 300 may include a guest operating system (guest OS) 310 and a guest kernel 330. The guest operating system 310 may include an application 311 and an analyzer 313, and the analyzer 313 may include a socket 315 corresponding to the hardware device 400. The guest kernel 330 may include a VirtIO device 331.

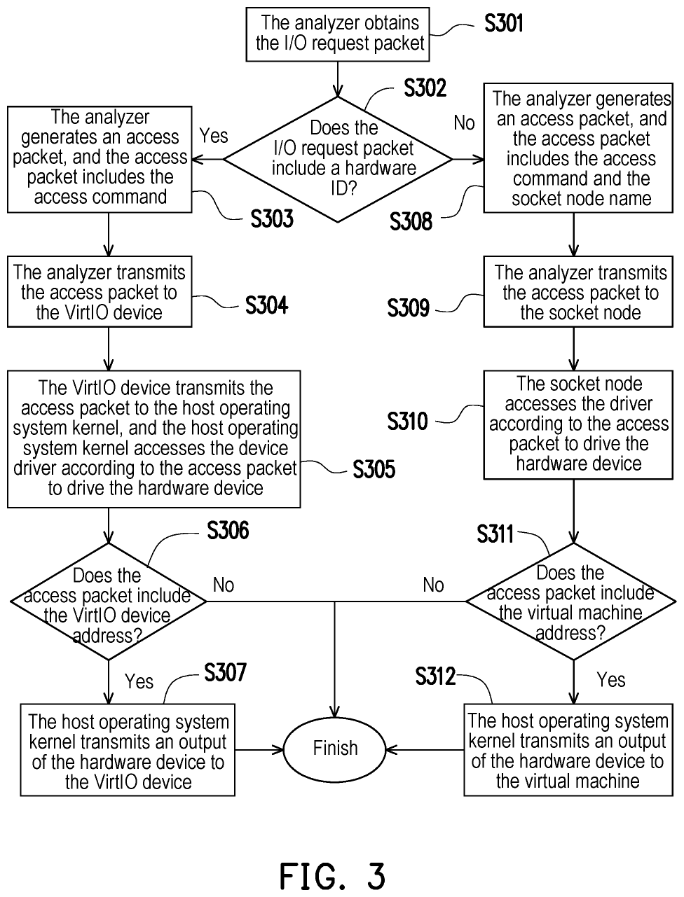

FIG. 3 illustrates a flow chart of a device pass-through method for a virtual machine according to an embodiment of the disclosure. The device pass-through method may be implemented by the server 100 as shown in FIG. 1. In this embodiment, assuming that the application 311 wants to access the hardware device 400, the virtual machine 300 may determine whether to access the hardware device 400 through the VirtIO device 331 or the socket 315 according to the device pass-through method.

Referring to FIGS. 2 and 3, in step S301, the guest kernel 330 may transmit an input and output (I/O) request packet (that is, an IRP packet) S2 to the analyzer 313, and the I/O request packet S2 corresponds to the hardware device 400. The analyzer 313 may obtain the I/O request packet S2 from the guest kernel 330. Specifically, the application 311 may receive data through the transceiver 130 and generate an I/O request command (or “I/O interrupt command”) S1 according to the received data. The I/O request command S1 may correspond to the hardware device 400. The application 311 may transmit the I/O request command S1 to the guest kernel 330, and the guest kernel 330 may transmit the I/O request packet S2 corresponding to the I/O request command S1 to the analyzer 313. The I/O request packet S2 may include a virtual function name (VF name) or a hardware ID (HW ID).

For example, the server 100 may be connected to an external input device (for example, a keyboard) through the transceiver 130. A user may operate the application 311 through the external input device to transmit the I/O request command S1 to the guest kernel 330. In another example, the server 100 may be connected to an external electronic device (for example, a terminal device or a server) through the transceiver 130. The application 311 may receive a command from the external electronic device through the transceiver 130 and transmit the I/O request command S1 to the guest kernel 330 according to the command.

In step S302, the analyzer 313 may determine whether the I/O request packet S2 includes a hardware ID. If the I/O request packet S2 includes the hardware ID, step S303 is proceeded to. If the I/O request packet S2 does not include the hardware ID, step S308 is proceeded to.

When the I/O request packet S2 includes the hardware ID, it means that there is the VirtIO device 331 dedicated to the hardware device 400 in the guest kernel 330. Therefore, if the guest kernel 330 determines that the I/O request command S1 is adapted for accessing the hardware device 400, the guest kernel 330 may encapsulate the hardware ID corresponding to the hardware device 400 and the VirtIO device 331 in the I/O request packet S2. The guest kernel 330 may instruct the analyzer 313 through the I/O request packet S2 to use the VirtIO device 331 to access the hardware device 400. On the other hand, if there is no VirtIO device dedicated to the hardware device 400 in guest kernel 330 (that is, the VirtIO device 331 does not belong to the hardware device 400), the guest kernel 330 cannot instruct the analyzer 313 to use the VirtIO device 331 to access the hardware device 400.

In step S303, the analyzer 313 may generate an access packet S3 corresponding to the hardware device 400 according to the I/O request packet S2, and the access packet S3 may include the access command used to access hardware device 400. In step S304, the analyzer 313 may transmit the access packet S3 to the VirtIO device 331 corresponding to the hardware ID.

In an embodiment, if the virtual machine 300 wants to obtain an output of the hardware device 400 after accessing the hardware device 400, the access packet S3 may further include a VirtIO device address 33 of the VirtIO device 331, and the VirtIO device address 33 is the memory address of the storage medium 120. Accordingly, the analyzer 313 may instruct the host operating system kernel 200 through the access packet S3 to feed the output of the hardware device 400 back to the virtual machine 300 through the VirtIO device address 33.

In step S305, the VirtIO device 331 may transmit the access packet S3 to the host operating system kernel 200. The host operating system kernel 200 may access the device driver 230 according to the access packet S3 to drive the hardware device 400. Specifically, the VirtIO device 331 may transmit the access packet S3 to a hardware device address 34 of the hardware device 400, and the hardware device address 34 is the memory address of the storage medium 120. The device driver 230 may obtain the access packet S3 from the hardware device address 34 and drive the hardware device 400 according to the access packet S3.

In step S306, the host operating system kernel 200 may determine whether the access packet S3 includes the VirtIO device address 33 of the VirtIO device 331. If access packet S3 includes the VirtIO device address 33, step S307 is proceeded to. If the access packet S3 does not include the VirtIO device address 33, the process is finished.

In step S307, the host operating system kernel 200 may transmit an output S4 of the hardware device 400 to the VirtIO device 331 according to the VirtIO device address 33 of the VirtIO device 331. The VirtIO device 331 may further transmit the output S4 of the hardware device 400 to the application 311.

In step S308, the analyzer 313 may generate an access packet S5 corresponding to hardware device 400 according to the I/O request packet S2, and the access packet S5 may include the access command used to access the hardware device 400 and the socket node name corresponding to the socket node 210.

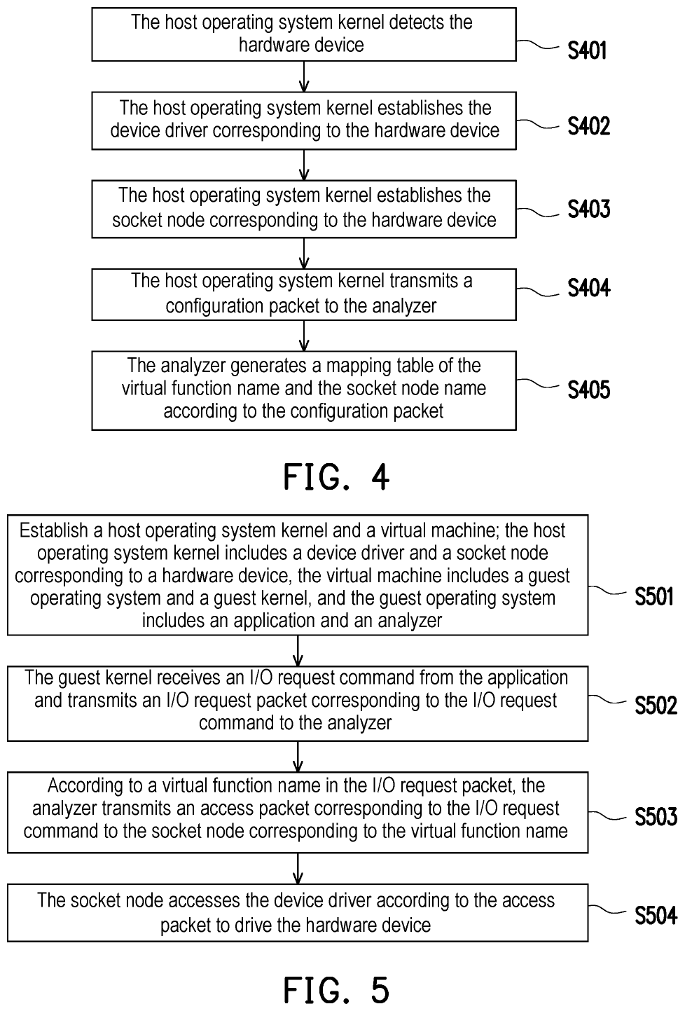

In step S309, the analyzer 313 may transmit the access packet S5 to the socket node 210 corresponding to the virtual function name, and the analyzer 313 and the socket node 210 may communicate with each other through a VM socket (vsock) protocol. Therefore, the virtual machine 300 may transmit the access packet S5 to the host operating system kernel 200 without executing a binary translation. Specifically, the analyzer 313 may store a mapping table of the virtual function name and the socket node name. After obtaining the virtual function name from the I/O request packet S2, the analyzer 313 may determine that the virtual function name corresponds to the socket node name of the socket node 210 according to the mapping table. Accordingly, the analyzer 313 may transmit the access packet S5 through the socket 315 to a socket node address 32 of the socket node 210, and the socket node address 32 is the memory address of the storage medium 120. In other words, the analyzer 313 may transmit access packet S5 to the socket node 210 corresponding to the virtual function name according to the mapping table. The method of establishing the mapping table is recorded in the embodiment of FIG. 4.

In an embodiment, if the virtual machine 300 wants to obtain the output of the hardware device 400 after accessing the hardware device 400, the access packet S5 may further include a virtual machine address 31 of the virtual machine 300, and the virtual machine address 31 is the memory address of the storage medium 120. Accordingly, the analyzer 313 may instruct the host operating system kernel 200 through access packet S5 to feed the output of the hardware device 400 back to the virtual machine 300 through the virtual machine address 31.

In an embodiment, the host operating system kernel 200 may add one to the count value corresponding to the socket node 210 in response to the socket node 210 receiving the access packet S5. The host operating system kernel 200 may output the count value of the socket node 210 through the transceiver 130 for the user's reference. For example, if the count value of the socket node 210 exceeds the threshold value within a certain period of time, the user may determine that the virtual machine 300 often needs to access the hardware device 400 corresponding to the socket node 210. Accordingly, the user may consider establishing a VirtIO device dedicated to the hardware device 400. The VirtIO device dedicated to the hardware device 400 may improve the efficiency of accessing the hardware device 400.

In step S310, the socket node 210 may access the driver 230 according to the access packet S5 to drive the hardware device 400.

In step S311, the host operating system kernel 200 may determine whether the access packet S5 includes the virtual machine address 31 of the virtual machine 300. If the access packet S5 includes the virtual machine address 31, step S312 is proceeded to. If the access packet S5 does not include the virtual machine address 31, the process is finished.

In step S312, the host operating system kernel 200 may transmit an output S6 of the hardware device 400 to the virtual machine 300 according to the virtual machine address 31 of the virtual machine 300. The application 311 in the virtual machine 300 may obtain the output S6 of the hardware device 400.

FIG. 4 illustrates a flow chart of a method of the hardware device 400 establishing a device pass-through channel according to an embodiment of the disclosure. The method may be implemented by the server 100 shown in FIG. 1. After establishing the pass-through channel of the hardware device 400, the server 100 may execute the method shown in FIG. 3.

In step S401, the host operating system kernel 200 may detect the hardware device 400 through the transceiver 130.

In step S402, the host operating system kernel 200 may establish (or launch) the device driver 230 corresponding to the hardware device 400.

In step S403, the host operating system kernel 200 may establish the socket node 210 corresponding to the hardware device 400.

In step S404, the host operating system kernel 200 may transmit a configuration packet to the analyzer 313. The configuration packet may include a hardware ID corresponding to the hardware device 400, and may include the socket node name and the socket node address corresponding to the socket node 210.

In step S405, the analyzer 313 may generate a mapping table of the virtual function name and the socket node name according to the configuration packet. Specifically, after receiving the configuration packet, the analyzer 313 may establish a virtual function corresponding to the hardware ID in the configuration packet (or the hardware device 400), and may generate a virtual function name corresponding to the virtual function. The virtual function name generated according to the configuration packet corresponds to the socket node name in the configuration packet. In other words, there is a mapping relationship between the virtual function name and the socket node name. Accordingly, the analyzer 313 may establish the mapping table of the virtual function name and the socket node name according to the mapping relationship. In addition, the analyzer 313 may establish the socket 315 corresponding to the socket node 210 according to the configuration packet.

FIG. 5 illustrates a flow chart of a device pass-through method for another virtual machine according to an embodiment of the disclosure. The device pass-through method may be implemented by the server 100 shown in FIG. 1. In step S501, a host operating system kernel and a virtual machine are established. The host operating system kernel includes a device driver and a socket node corresponding to a hardware device. The virtual machine includes a guest operating system and a guest kernel. The guest operating system includes an application and an analyzer. In step S502, the guest kernel receives an I/O request command from the application and transmits an I/O request packet corresponding to the I/O request command to the analyzer. In step S503, according to a virtual function name in the I/O request packet, the analyzer transmits an access packet corresponding to the I/O request command to the socket node corresponding to the virtual function name. In step S504, the socket node accesses the device driver according to the access packet to drive the hardware device.

In summary, when the analyzer of the disclosure receives the I/O request packet, the analyzer of the disclosure may determine whether to use the VirtIO device to access the host operating system kernel. When the analyzer determines not to use the VirtIO device, the analyzer may access the hardware device through communicating with the socket node dedicated to the hardware device. Compared with accessing a hardware device through a virtual device by a conventional virtual machine, accessing the hardware device through the socket node may avoid the occurrence of a binary translation process, thereby reducing the waste of computing resources. In addition, the host operating system kernel of the disclosure may count the number of times the socket node is accessed for the users' reference. The user may decide whether to develop a VirtIO device dedicated to a corresponding hardware device according to the number of times the socket node is accessed. If the access packet includes the virtual machine address, the host operating system kernel may transmit the output of the hardware device back to the virtual machine according to the virtual machine address. On the other hand, when the host operating system kernel detects a new hardware device, the host operating system kernel may transmit relevant information of the new hardware device to the analyzer. The analyzer may access the hardware device according to the relevant information.

What is claimed is:

1. A server of a virtual machine, comprising:
a transceiver;
a storage medium, storing a plurality of modules; and
a processor, coupled to the storage medium and the transceiver, accessing and executing the modules, wherein the modules comprise:
a host operating system kernel, communicatively connected to a hardware device through the transceiver, comprising a device driver and a socket node corresponding to the hardware device; and
a virtual machine, comprising a guest operating system and a guest kernel, wherein the guest operating system comprises an application and an analyzer, wherein
the guest kernel receives an I/O request command from the application and transmits an I/O request packet corresponding to the I/O request command to the analyzer, wherein
according to a virtual function name in the I/O request packet, the analyzer transmits an access packet corresponding to the I/O request command to the socket node corresponding to the virtual function name, wherein
the socket node accesses the device driver according to the access packet to drive the hardware device.

2. The server according to claim 1, wherein the guest kernel comprises a VirtIO device, wherein the I/O request packet comprises one of the virtual function name and a hardware ID, wherein in response to the I/O request packet comprising the hardware ID, the analyzer transmits the access packet to the host operating system kernel through the VirtIO device corresponding to the hardware ID, wherein the host operating system kernel accesses the device driver according to the access packet to drive the hardware device.

3. The server according to claim 1, wherein in response to the socket node receiving the access packet, the host operating system kernel adds one to a count value corresponding to the socket node, wherein the host operating system kernel outputs the count value through the transceiver.

4. The server according to claim 1, wherein the analyzer generates the access packet according to the I/O request packet, wherein the access packet comprises an access command and a socket node name corresponding to the socket node.

5. The server according to claim 4, wherein the access packet further comprises a virtual machine address corresponding to the virtual machine, wherein in response to driving the hardware device, the socket node transmits an output of the hardware device to the virtual machine according to the virtual machine address.

6. The server according to claim 2, wherein the access packet comprises a VirtIO device address corresponding to the VirtIO device, wherein in response to driving the hardware device, the host operating system kernel transmits an output of the hardware device to the VirtIO device according to the VirtIO device address.

7. The server according to claim 1, wherein the host operating system kernel detects the hardware device through the transceiver and establishes the device driver and the socket node in response to detecting the hardware device.

8. The server according to claim 7, wherein in response to detecting the hardware device, the host operating system kernel transmits a configuration packet to the analyzer, wherein the configuration packet comprises a hardware ID corresponding to the hardware device, a socket node address corresponding to the socket node, and a socket node name corresponding to the socket node.

9. The server according to claim 8, wherein the analyzer generates a mapping table of the virtual function name and the socket node name according to the configuration packet.

10. The server according to claim 9, wherein the analyzer transmits the access packet to the socket node corresponding to the virtual function name according to the mapping table.

11. The server according to claim 1, wherein the analyzer and the socket node communicate with each other through a vsock protocol.

12. A device pass-through method for a virtual machine, comprising:
establishing a host operating system kernel and a virtual machine, wherein the host operating system kernel comprises a device driver and a socket node corresponding to a hardware device, wherein the virtual machine comprises a guest operating system and a guest kernel, wherein the guest operating system comprises an application and an analyzer;
receiving an I/O request command from the application and transmitting an I/O request packet corresponding to the I/O request command to the analyzer by the guest kernel;
according to a virtual function name in the I/O request packet, transmitting an access packet corresponding to the I/O request command to the socket node corresponding to the virtual function name by the analyzer; and
accessing the device driver according to the access packet to drive the hardware device by the socket node.
